(19) United States
(12) Patent Application Publication
(10) Pub. No.: US 2022/0300752 A1
(43) Pub. Date: Sep. 22, 2022

(54) AUTO-DETECTION OF FAVORABLE AND UNFAVORABLE OUTLIERS USING UNSUPERVISED CLUSTERING

(71) Applicant: SAP SE, Walldorf (DE)

(72) Inventors: Pritam Roy, Howrah (IN); Avinash Permude, Bangalore (IN); Nithya Rajagopalan, Bangalore (IN)

(21) Appl. No.: 17/203,101

(22) Filed: Mar. 16, 2021

(51) Int. Cl. G06K 9/62; G06N 20/00

(52) U.S. Cl. CPC G06K 9/6218; G06K 9/6298; G06N 20/00

(57) ABSTRACT

Methods, systems, and articles of manufacture, including computer program products, are provided for auto-detection of favorable outliers and unfavorable outliers using unsupervised clustering.

### FIELD

The present disclosure generally relates to machine learning.

### BACKGROUND

Many organizations may rely on enterprise software applications including, for example, enterprise resource planning (ERP) software, customer relationship management (CRM) software, and/or the like. These enterprise software applications may provide a variety of functionalities including, for example, invoicing, procurement, payroll, time and attendance management, recruiting and onboarding, learning and development, performance and compensation, workforce planning, and/or the like. Some enterprise software applications may be hosted by a cloud-computing platform such that the functionalities provided by the enterprise software applications may be accessed remotely by multiple end users. For example, an enterprise software application may be available as a cloud-based service including, for example, a software as a service (SaaS) and/or the like.

### SUMMARY

Methods, systems, and articles of manufacture, including computer program products, are provided for auto-detection of favorable outliers and unfavorable outliers using unsupervised clustering.

In some embodiments, there is provided a method that includes receiving a plurality of objects; preprocessing the plurality of objects by at least normalizing one or more terms of the plurality of objects; determining, for each of the plurality of objects, an aggregate value based on the one or more terms of the plurality of objects; identifying, based on unsupervised learning clustering, at least one of a favorable outlier and an unfavorable outlier among the plurality of objects; in response to identifying an unfavorable outlier, removing the identified unfavorable outlier from the plurality of objects; and in response to removing the identified unfavorable outlier, providing at least one of the remaining plurality of objects.

In some variations, one or more of the features disclosed herein including the following features can optionally be included in any feasible combination. The unsupervised learning clustering may include clustering based on an average gap value among aggregate values. The unsupervised learning clustering may include sorting aggregate values generated for the plurality of objects and determining an average gap value among the aggregate values. The unsupervised learning clustering may include if a gap between a first aggregate value and a second aggregate value is less than or equal to the average gap value, the first aggregate value is assigned to a first cluster; and if a gap between a first aggregate value and a second aggregate value is more than the average gap value, the first aggregate value is assigned to a second cluster. The preprocessing may further include identifying a first term from the one or more terms as a maximization term; and negating, before the determining of the aggregate value, the first term. The normalizing may include determining a z-score for the one or more terms for each of the plurality of objects. The determining of the aggregate value may include determining a sum of the normalized one or more terms for each of the plurality of objects. The providing at least one of the remaining plurality of objects may include generating a user interface including an indication of the at least one of the remaining plurality of objects including the favorable outlier; and causing the generated user interface to be presented at a client device. The plurality of objects may include a plurality of bids.

It is to be understood that both the foregoing general description and the following detailed description are exemplary and explanatory only and are not restrictive. Further features and/or variations may be provided in addition to those set forth herein. For example, the implementations described herein may be directed to various combinations and subcombinations of the disclosed features and/or combinations and subcombinations of several further features disclosed below in the detailed description.

### DESCRIPTION OF THE DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1A depicts an example of a system for detecting outliers, in accordance with some example embodiments;

FIG. 1B plots clusters including a favorable outlier and an unfavorable outlier, in accordance with some example embodiments;

FIG. 2A depicts another example of a system for detecting outliers, in accordance with some example embodiments;

FIG. 2B depicts an example process for outlier detection, in accordance with some example embodiments;

FIG. 3 depicts an example process for gap-based clustering without supervision, in accordance with some example embodiments; and

FIG. 4 depicts a block diagram illustrating a computing system 400 consistent with implementations of the current subject matter.

Like labels are used to refer to same or similar items in the drawings.

### DETAILED DESCRIPTION

Detecting outliers is a challenging machine-learning problem. To illustrate, the following example is provided. Pat is a senior category buyer at Acme Inc., and Pat is responsible for sourcing of all base chemicals used to make a product manufactured by Acme Inc. To that end, Pat may create, via a client device, a sourcing event that triggers at a periodic interval, such as every quarter. This sourcing event checks whether other suppliers are available for some if not all of the base chemicals in an effort to reduce the build of materials associated with the base chemicals for the product. This sourcing event may include a plurality of items including terms defining the requirements for each of the base chemicals, and may include identifying a plurality of candidate suppliers from a variety of locations. For example, the sourcing event may include a request for bids being sent electronically to each of the plurality of candidate suppliers each of which is associated with a corresponding client device. In response to the request for bids, Pat may receive electronically a plurality of responses in the form of a bid, for example. Once the bidding process is over, Pat may apply an optimizer to identify one or more “best” bids. This optimizer may identify the best bids based on one or more constraints. These constraints may include values, such as price, quality, lead time (e.g., time until delivery of product) and/or other factors, requirements, or constraints (which may be pre-defined or defined, via a user interface, by Pat or one or more entities at Acme Inc., for example).

However, some, if not all, optimizers may require Pat to manually filter out outlier bids by manually defining one or more criteria to identify the outlier bids, such that the outliers can be removed before the optimizer selects the best bid(s). Moreover, the manual filtering may be difficult given the large quantity of bids being processed and the differences in the values of the constraints. From an ERP planning perspective, the removal of outlier bids may be important as awarding a bid to an outlier may represent awarding a bid to an ill-suited supplier.

In some embodiments, there is provided an outlier detection engine to identify outliers. In some embodiments, the outlier detection engine uses an unsupervised learning clustering algorithm to identify outliers including favorable outliers and unfavorable outliers. In some implementations, the outlier detection identifies one or more outliers based on some, if not all, of the constraints, such as the numerical terms of a corresponding bid, to detect a potential outlier bid from the bid responses provided by, for example, the supplier.

Although some of the examples refer to outlier detection in the context of bids, the outlier detection including the unsupervised learning disclosed herein may be applied to other types of data as well. For example, an object, such as an electronic document or other type of data structure, may include one or more constraints (e.g., requirements, values, attributes, etc.) that can be represented numerically as a vector, an array, and/or other type of data format, such that the outlier detection including the unsupervised learning disclosed herein may be used to detect outliers in these objects as well.

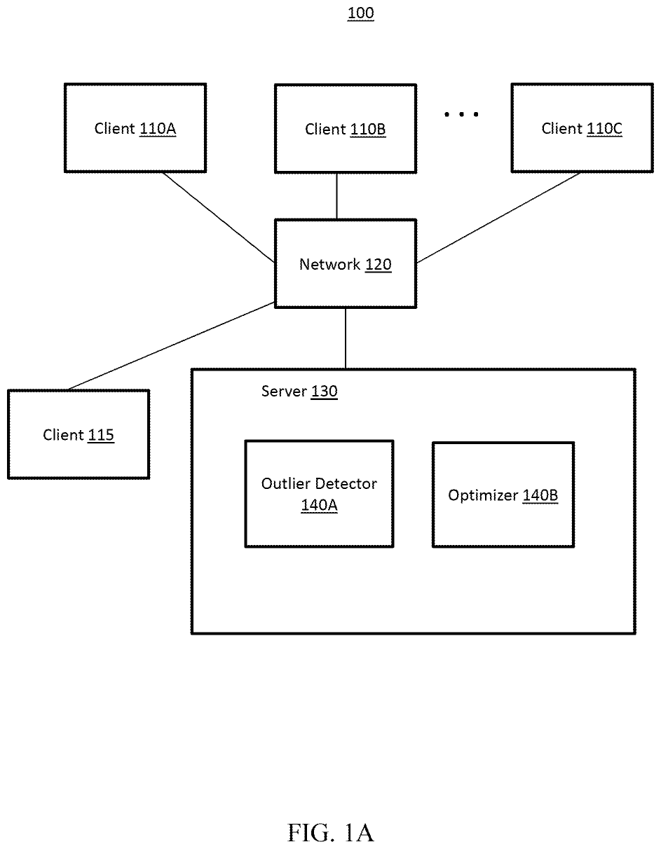

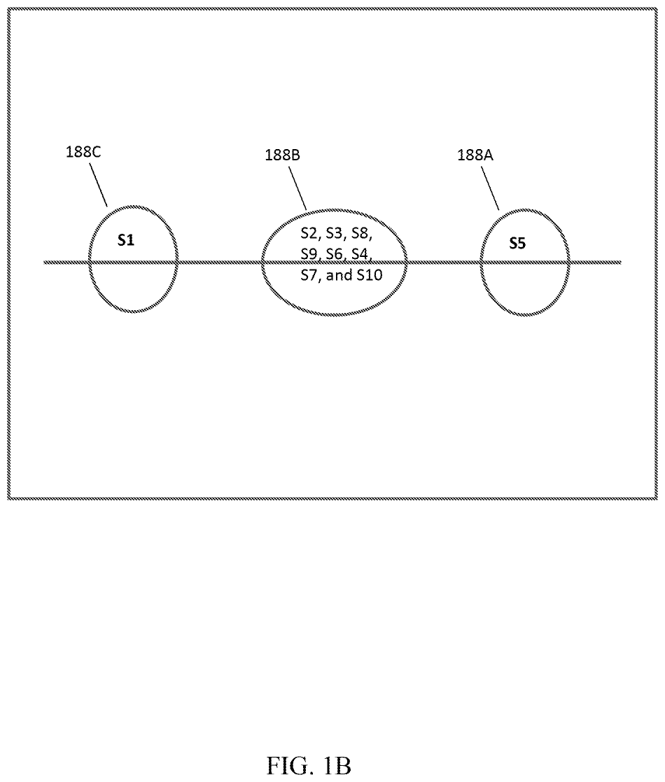

FIG. 1A depicts an example of a system 100 for detecting outliers in objects, such as bids and/or the like. The system 100 may include one or more client devices 110A-C coupled to a network, such as the Internet or any other type of communication mechanism. The client devices 110A-C may each be associated with, or located at, a provider (or generator) of the object. For example, the client devices 110A-C may be associated with, or located at, a supplier providing the bid. The client devices may comprise a computer, a smart phone, or other types of processor-based devices. In the example of FIG. 1A, the client 115 may be associated with, or located at, a receiver (or processor) of the objects, such as Pat or Acme in the example above.

Referring to the previous Acme example for illustration, the client 115 may trigger a sourcing event for a plurality of items, such as chemicals. Each item may have an associated set of terms, such a price, a quantity, a quality, etc., and these terms define the requirements (or, e.g., constraints) for each of the base chemicals. In the Acme example, the triggered sourcing event causes one or more messages to be sent to clients 110A-C to request bids. In some implementations, the bid request messages sent to the clients 110A-C are sent by client 115 via network 120. Alternatively, or additionally, the bid request messages sent to client 110A-C are sent by server 130 via network 120 (e.g., the sourcing event is stored at server 130 for client 115 and, when triggered causes the bid request messages to be sent to the clients 110A-C).

In response to the bid request messages being sent to (and received by) the clients 110A-C, the clients 110A-C may send via network 120 responsive bids to the server 130. Alternatively, or additionally, the bids may be sent to the client 115, which in term provides the bids to the server 130.

The server 130 including the outlier detector 140A may process the bids to detect outliers. In some embodiments, the outlier detector 140A detects at least one “favorable” outlier and at least one “unfavorable outlier.” Next, the optimizer 140A may select the one or more “best” bids from the received bids. In some embodiments, before this selection of the one or more “best” bids, the optimizer may remove one or more of the detected outliers. For example, the optimizer may remove one or more unfavorable outliers, and then select the one or more “best” bids.

In some implementations, the server 130 may generate a user interface including the favorable outlier and/or the unfavorable outlier. And, the server 130 may cause the generation of a user interface (which includes the favorable outlier and/or the unfavorable outlier) to be presented at the client 115. Alternatively, or additionally, the server may generate a user interface including the best bid(s), and the server 130 may cause the generated user interface to be presented at the client 115.

In some embodiments, the outlier detector 140A and/or optimizer 140B are provided as a service, such as a SaaS on a cloud-based platform accessible via network 120 to a plurality of clients. In some embodiments, the outlier detector 140A and optimizer 140B are incorporated into a single engine to identify optimum bids. As noted, although some of the examples refer to outlier detection in the context of bids, the outlier detection may be used with other types of objects.

In some embodiments, the server 130 may receive a plurality of objects, such as the electronic bids (referred to herein as “bids”). When this is the case, the server may preprocess each of the bids. For example, each bid may include a plural of terms, such as price, units, unit of measure, delivery dates, quality indication of the good or service, requirements, constraints, and/or other values. In some embodiments, the preprocessing may include normalizing the terms to enable comparisons. For example, the value of a price term may be normalized (e.g., standardized) to a predetermined range. To illustrate further, a price term value may be normalized so each of the price term values fall with a range of 100 to 500. Likewise, a lead time value may be normalized to a range of 5 to 20 days, and so forth. Likewise, units of measures and currency may also be normalized (e.g., converting pounds to grams, Dollars to Euros, etc.). The range for the normalization may be predefined at the server 130 and/or selected via a user interface at a client device.

The preprocessing may also classify (e.g., identify) one or more of the terms of a bid as a minimization term or a maximization term. A term may be classified as a minimization term if, from the perspective of client 115 (who is evaluating bid messages), the term should be minimized. Examples of minimization terms include price, days to delivery, risk factor, and/or other terms that from the perspective of the client 115 provide an optimum result when minimized. A term may be classified as a maximization term if, from the perspective of client 115 (who is evaluating bid messages), the term should be maximized. Examples of maximization terms include quality of goods and/or other terms that from the perspective of the client 115 provide an optimum result when maximized.

In some implementation, the normalization (also referred to as standardization) may be performed using a statistical function, such as a z-score

$$( e . g . , z = \frac{x - μ}{σ} ) ,$$

wherein x is the value being standardized, μ is mean, and σ is the standard deviation of the samples. The normalization may thus allow processing terms that are on different, relative scales (e.g., prices with a wide range so normalized to a predetermined range of, for example, $1000 to $2000, lead time ranging in 5 to 10 days, and so forth).

In some embodiments, a term classified as a maximization term is normalized by negating the value of the term. For example, if a quality factor term varies from 1 to 10 (where 10 represents the highest quality of the good being supplied), the preprocessing may flag this quality factor term as a maximization term, such that when this term is normalized, the term is also negated (e.g., −1 to −10). In this way, the highest quality represents a minimum, such as “−10” in this example, along with the other terms, such as price and so forth being optimized.

After the pre-processing, each bid may be further processed. For each supplier (e.g., clients 110A-C) providing a bid, the outlier detector 140A may preprocess each of the terms of a bid as noted above. Table 1 below depicts an example of 10 bids from suppliers S1-S10, wherein each bid includes 3 terms, such as price, lead time, and a quality factor, although other quantities of suppliers and types of terms may be implemented as well.

To normalize the terms at Table 1, the terms may be preprocessed as follows. For the price term which varies across suppliers from 62 to 126 (with a mean value (μ) for price data of 91 and a standard deviation of 15.48), the price 62 for S1 is normalized to −1.87 (e.g., (62−91)/15.48=−1.87). Likewise, the price 78 for S2 is normalized to −0.84 (e.g., (78−91)/15.48=−0.84); and so forth as depicted at Table 2 at the “Price_Standard” row. Table 2 depicts the price, lead time, and Quality Factor terms followed by the preprocessing that normalizes those values. The respective normalized/standardized values are listed in “Price_Standard” row, “LeadTime_Standard” row, and “Quality_Standard” row.

TABLE 1

| Terms | S1 | S2 | S3 | S4 | S5 | S6 | S7 | S8 | S9 | S10 |
|---|---|---|---|---|---|---|---|---|---|---|
| Price | 62 | 78 | 84 | 88 | 90 | 93 | 94 | 96 | 99 | 126 |
| Lead_Time | 10 | 8 | 9 | 12 | 62 | 8 | 15 | 4 | 8 | 5 |
| Quality_Factor | 52 | 20 | 22 | 10 | 5 | 11 | 17 | 20 | 22 | 30 |

Although the example of Table 1 depicts 10 suppliers with 3 terms being optimized, this is an example for purposes of illustration. Indeed, the outlier detector 140A may process hundreds of bids; each bid may include hundreds if not thousands of items; each item may include includes hundreds of terms (e.g., requirements). These large quantities make optimization based on the terms a computationally burdensome problem. As such, the processes disclosed herein may provide optimization in a more computationally efficient way while still maintaining the fidelity of the terms for each of the bids.

After all of the terms are normalized, the outlier detector 140A may then determine, for each supplier, a score, such as an aggregate value or other function indicative of the normalized term values of a given supplier. Referring to Table 2 for example, the aggregate value (e.g., the “Total_Weightage”) for each supplier is a sum of each of the standardized/normalized values for a given supplier. For supplier S1 for example, the aggregate, such as the Total_Weightage, is −4.63 (e.g., −1.87+−0.25+−2.51=−4.63). Likewise, for supplier S2 for example, the aggregate, such as the Total_Weightage, is −1.15, and so forth through the suppliers. For each supplier, the Total_Weightage represents a normalized, weighted score across the terms (e.g., price, lead time, and quality factor).

TABLE 2

| Terms | S1 | S2 | S3 | S4 | S5 | S6 | S7 | S8 | S9 | S10 |
|---|---|---|---|---|---|---|---|---|---|---|
| Price | 62.00 | 7.00 | 84.00 | 88.00 | 90.00 | 93.00 | 94.00 | 96.00 | 99.00 | 126.00 |
| Lead_Time | 10.00 | 8.00 | 9.00 | 12.00 | 62.00 | 8.00 | 15.00 | 4.00 | 8.00 | 5.00 |
| Quality_Factor | 52.00 | 20.00 | 22.00 | 10.00 | 5.00 | 11.00 | 17.00 | 20.00 | 22.00 | 30.00 |
| Price_Standard | −1.87 | −0.84 | −0.45 | −0.19 | −0.06 | 0.13 | 0.19 | 0.32 | 0.52 | 2.26 |
| LeadTime_Standard | −0.25 | −0.38 | −0.31 | −0.13 | 2.95 | −0.38 | 0.06 | −0.62 | −0.38 | −0.56 |
| Quality_Standard | −2.51 | 0.07 | −0.09 | 0.88 | 1.28 | 0.80 | 0.31 | 0.07 | −0.09 | −0.73 |
| Total_Weightage | −4.63 | −1.15 | −0.85 | 0.56 | 4.17 | 0.06 | 0.56 | −0.23 | 0.05 | 0.97 |

In the example of Table 2, the Quality_Standard was classified and thus identified as a maximization term. As such, the Quality_Standard values are negated (e.g., multiplied by minus 1 (“−1”)) as part of the pre-processing to yield the normalized/standardized values, such as −2.51, 0.07, −0.09, and so forth. In this way, a term that corresponds to a maximization term is negated and thus converted into a minimization term for purposed of optimization. In other words, all of the terms being optimized are normalized/standardize so that they are being minimized for optimization. This negation also provides that after clustering, data points that are on left most clusters will be potential favorable outliers and data points on right most clusters will be the potential unfavorable ones (as explained further below with respect to FIG. 1B).

Although the example of Table 2 negated the maximization term, the preprocessing may, alternatively, negate the minimization terms, which in this example are Price_Standard and LeadTime_Standard values. When this is the case, the minimization terms are normalized to maximization terms by negating the minimization terms, so after clustering, data points on right most clusters will be the potential favorable outliers and data points on left most clusters will be the potential unfavorable ones.

After the aggregate data is determined (e.g., Total_Weightage is calculated at Table 2 for each bid from each supplier), the outlier detector 140A may determine outliers, such as a favorable outlier and an unfavorable outlier. For example, the outlier detector 140A may identify the outliers based on a clustering algorithm. In some embodiments, the clustering is performed based on an unsupervised learning clustering algorithm disclosed herein. This algorithm is unsupervised in the sense that training data is not needed to train the outlier detector to cluster the data, such as the Total_Weightage data.

To illustrate, the outlier detector 140 may process the “Total_Weightage” values of Table 2 to identify outlier bids. In some embodiments, the identified outliers correspond to a favorable outlier and an unfavorable outlier. The favorable outlier represents a bid that is favorable to the buyer, so the favorable bid, although an outlier, should not be removed or filtered. For example, a given supplier may have submitted a very low price compared to others, wherein this low price bid also has a high quality factor. In this example, the outlier detector 140A should not identify and remove this outlier because it is a favorable outlier. Instead, the outlier detector 140A may generate an indication of the favorable outlier and/or cause the favorable outlier to be presented, via a user interface, to client 115. By contrast, an unfavorable outlier represents a bid that is unfavorable to the client 115. For example, the bid may have a high price and include a low quality score. In this unfavorable outlier case, the outlier detector 140A detects the unfavorable outlier and automatically filters (e.g., removes) it from further optimization processing.

In some example embodiments, the clustering may be performed based on an unsupervised learning clustering algorithm that uses gap analysis. For example, the outlier detector 140A may sort the aggregate data for each bid, such as a sort of the Total_Weightage values in ascending order. Next, the outlier detector 140A may calculate an average gap for each of the aggregate data. For example, for the Total_Weightage of Table 2, the average gap may be determined as follows:

avg_gap=range of Total_Weightage values/quantity of suppliers.

The outlier detector 140A may also determine the individual gap between each supplier's Total_Weightage values. The outlier detector 140 may sequentially compare each individual gap value with the average gap. If an individual gap value is less than the average gap, then the data points are in same cluster. If the individual gap value is greater than the average gap, a cluster may be considered “closed” and new cluster is formed using the current data sample. This process is continued through all of the Total_Weightage values for all of the suppliers. At the end of gap/outlier processing, the outlier detector 140A forms at least one cluster, which can be used to identify favorable outliers, unfavorable outliers, etc.

Table 3 depicts the Total_Weightage values of Table 2 sorted in ascending order. The outlier detector 140A determines the average gap as 0.88 (e.g., (4.17−(−4.63))/10=0.88).

TABLE 3

| Terms | S1 | S2 | S3 | S4 | S5 | S6 | S7 | S8 | S9 | S10 |
|---|---|---|---|---|---|---|---|---|---|---|
| Total_Weightage | −4.63 | −1.15 | −0.85 | −0.23 | 0.05 | 0.55 | 0.56 | 0.56 | 0.97 | 4.17 |

The outlier detector 140A iterates over the sorted Total Weightage values. For example, the individual gap between S1 and S2 is 3.45 (e.g., the absolute value of (−4.63−(−1.15)). For this first iteration, 3.45 is greater than the average gap of 0.88, so the outlier detector places S1 in a first cluster and forms a new cluster 2. Next, the outlier detector determines the individual gap between S2 and S3 as 0.30, which is smaller than or equal to average gap, so S2, S3 are associated with cluster 2. Likewise, the gap between S3 and S8 is 0.62, which is smaller than or equal to average gap, so S2, S3, and S8 are in cluster 2. Next, the individual gap between S8 and S9 is 0.28, which is smaller than or equal to average gap so cluster 2 now includes S2, S3, S8, and S9. And, the gap between S9 and S6 is 0.50, which is smaller than or equal to average gap, so cluster 2 now includes S2, S3, S8, S9, and S6. Similarly, the gap between S6 and S4 is 0.01, which is smaller than or equal to average gap, so cluster 2 now includes S2, S3, S8, S9, S6, and S4. Next, the individual gap between S4 and S7 is 0.00, which is smaller than or equal to average gap so cluster 2 now includes S2, S3, S8, S9, S6, S4, and S7. The outlier detector proceeds to determine the individual gap between S7 and S10 as 0.41, which is smaller than or equal to average gap so cluster 2 includes S2, S3, S8, S9, S6, S4, S7, and S10. And, the gap between S10 and S5 is 3.2, which is greater than the average gap, so S5 is included in cluster 3. At the end of the iteration, the outlier detector forms 3 clusters as follows: cluster 1 that includes the bid for S1 (a left most cluster or most favorable one); cluster 2 that includes bids from S2, S3, S8, S9, S6, S4, S7, and S10; and cluster 3 that includes a bid from S5 (a right most cluster or unfavorable one).

FIG. 1B depicts an example of the clustering results of Table 3. Referring to FIG. 1B, the clustering is plotted to show the third cluster 188A including the bid from supplier S5, which in this example is considered an unfavorable outlier. The plot also depicts the second cluster 188B including the bids from S2, S3, S8, S9, S6, S4, S7, and S10. Lastly, the plot depicts the first cluster 188C including the bid from supplier S1, which in this example is considered a favorable outlier. The server 130 may generate a user interface and cause the generated user interface to be presented at a client device, such as client device 115. This generated user interface may depict one or more of the clusters 188A-C to enable identification of the favorable outlier, unfavorable outliers, and the like.

After the clustering, the outlier detector 140A selects which bids will be filtered out (e.g., removed). In some implementations, a threshold is set that defines a percentage of data samples considered outliers. The threshold may be defined at the server 130 and/or selected via a user interface presented at a client device. For example, the threshold may be set at 10%, in which case 10% of the 10 bids for suppliers S1-S10 may be identified as outliers. In this example, only one of the bids may be discarded as an outlier. Moreover, as the outlier detector distinguishes between favorable and unfavorable outliers, only one of the unfavorable outliers may be discarded in this example. Referring to the three clusters, the bid associated with S5 in cluster 3 is removed. In some embodiments, the client 115 receives an indication via a user interface that S1 is the most favorable outlier. In some embodiments, the remaining bids in clusters 1 and 2 are provided to optimizer 140B for further optimization, the results of which are provided to client 115. Alternatively, or additionally, the optimizer 140B may select the optimum bid, which in this example corresponds to the bid in cluster 188C. If cluster 188C included a plurality of bids, the optimizer may generate a user interface for presentation at a client device, such that the user interface includes the bids in cluster 188C. Alternatively, or additionally, if cluster 188C included a plurality of bids, the optimizer may select the optimum bid among the bids in cluster 188C (which in this example would represent the bid with the lowest Total_Weightage value (or leftmost bid).

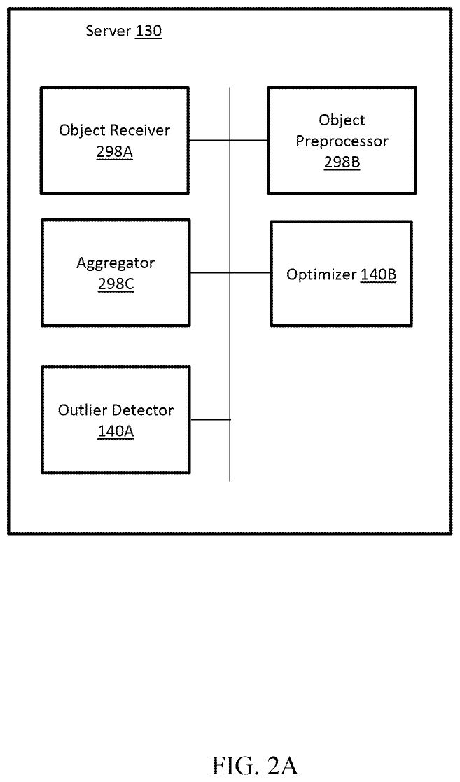

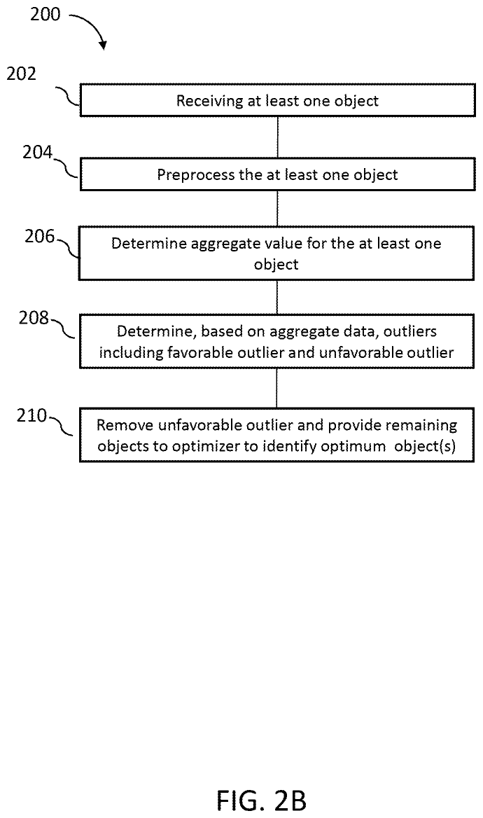

FIG. 2A depicts another example of the server 130. In the example of FIG. 2A, the server further includes an object receiver 298A, an object preprocessor 298B, and an aggregator 298C.

The object receiver 298A may be configured to receive one or more objects, such as bids from the clients 110A-C. For example, the object receiver may receive the object and parse the received object so that the item (e.g., data) of interest remains. In the example of the object being a bid, the object receiver may parse out terms from the object, such that optimization and outlier detection is performed on the parsed terms. In the example of Tables 2 and 3, the values associated with Price, Lead_Time, and Quality_Factor remain after parsing. The object preprocessor 298B may be configured to preprocess the received objects by at least normalizing the received objects. In the case of bids, the object preprocessor 298B may prepare the bids for outlier detector 140A by normalizing the terms, such as the data included in the bids. The aggregator 298C may be configured to determine an aggregate value, such as scores or total weighted values, for each of the objects, such as the bids.

FIG. 2B depicts an example process for outlier detection, in accordance with some example embodiments.

At 202, at least one object may be received. For example, the server 130 (e.g., the outlier detector 140A and/or the object receiver 298A) may receive at least one object such as a bid, from at least one of the clients 110A-C. As noted above with respect to Table 1, the bids may include data terms, such as values for price, lead time (e.g., time from order of item to delivery), quality factor (e.g., a measure of the quality or grade of the item), and/or the like. In some embodiments, the object, such as the bid, is parsed such that the items of interest (e.g., numerical data associated with price, lead time, quality factor, and the like) remain.

At 204, the at least one object may be preprocessed. For example, the server 130 (e.g., the outlier detector 140A and/or object preprocessor 298B) may preprocess the objects such as the bids by normalizing the data associated with the bids. For example, the normalization may include normalizing, for each bid, one or more terms, such as the price term value, lead time value, quality, and/or the like. An example of the normalization is depicted above with respect to Table 2 at Price_Standard, Quality_Standard, and LeadTime_Standard. Moreover, the preprocessing may include negating the value of a term that is classified as a maximization term.

At 206, an aggregate value, such as the Total_Weightage may be determined. For example, the server 130 (e.g., the outlier detector 140A and/or object preprocessor aggregator 298C) may calculate the Total_Weightage as described above with respect to Table 2. For each supplier, the Total_Weightage represents a normalized, weighted score across the terms (e.g., price, lead time, and quality factor).

At 208, the server 130 (e.g., outlier detector 140A) may determine, based on the aggregate data, outliers including favorable and unfavorable outliers. For example, the outlier detector 140A may include a clustering algorithm to identify outliers, which may include one or more unfavorable outliers and one or more favorable outliers. In some embodiments, an unsupervised learning clustering algorithm may be used for clustering. In some embodiments, the unsupervised learning clustering algorithm may include a gap analysis for the clustering.

In response to the presence or detection of an unfavorable outlier, the unfavorable outlier may be removed, at 210, and the remaining data for the objects, such as the bids, may be provided to a user interface (e.g., at client 115) and/or an optimizer 140B for further optimization and ultimately selection of an object such as a bid. For example, the server 130 may generate a user interface and cause the generated user interface to be presented at a client device, such as client device 115. This generated user interface may depict indicate the object having the highest aggregate value (e.g., Total_Weightage) and, as such, the optimum object, such as the optimum bid. In some instances, this optimum bid may correspond to a favorable outlier.

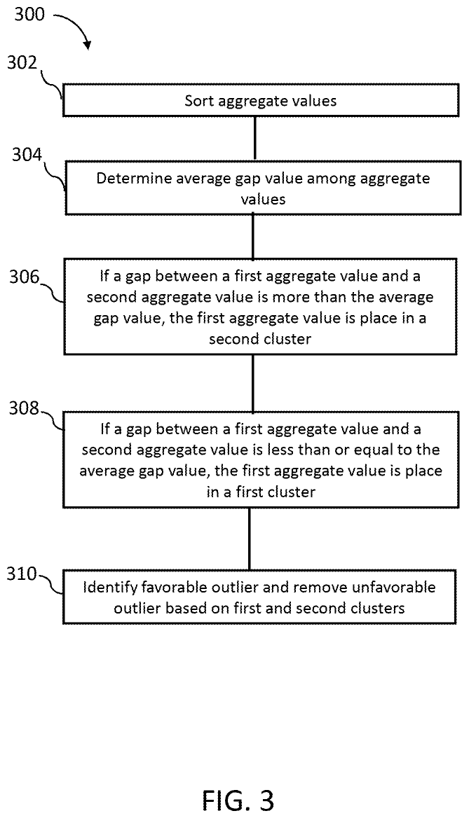

FIG. 3 depicts an example process for gap-based clustering without supervision, in accordance with some example embodiments.

At 302, the aggregate values, such as the Total_Weightage, may be sorted. For example, the aggregate values may be sorted in ascending order as depicted at Table 3 above.

At 304, an average gap value may be determined among the aggregate values. Referring again Table 3, the outlier detector 140A determines the average gap as 0.88 (e.g., (4.17−(−4.63))/10=0.88), for example.

At 306, if a gap between a first aggregate value and a second aggregate value is more than the average gap value, the first aggregate value is place in a second cluster. Referring to the example above where the gap between S10 and S5 is 3.2, which is greater than the average gap. The bid for S5 is included in cluster 3. At 308, if a gap between a first aggregate value and a second aggregate value is less than or equal to the average gap value, the first aggregate value is place in a first cluster. Referring to the example above, if the outlier detector determines the individual gap between S2 and S3 as 0.30, which is smaller than or equal to average gap, so S2, S3 are associated with cluster 2. The gap processing may proceed through the sorted aggregate values until some, if not all, of the aggregate values are placed in a cluster. FIG. 1B depicts an example of the clusters 188A-C formed based on the unsupervised learning clustering algorithm disclosed herein.

In some implementations, there is provided auto detection of outliers of objects, such as bids. The outlier detection may consider some, if not all the item terms, of the object using an efficient, unsupervised learning clustering algorithm. In some implementations, favorable outliers and unfavorable outliers are distinguished and identified. In some implementations, the best (e.g., optimum) bid among all the bids is identified taking in to account the bidding terms for a line item and/or after removal of certain outliers. After detecting bids as favorable or unfavorable outliers, a recommendation may be provided to a client device to indicate which bidding term most affected the bid being selected as a favorable outlier or an unfavorable outlier.

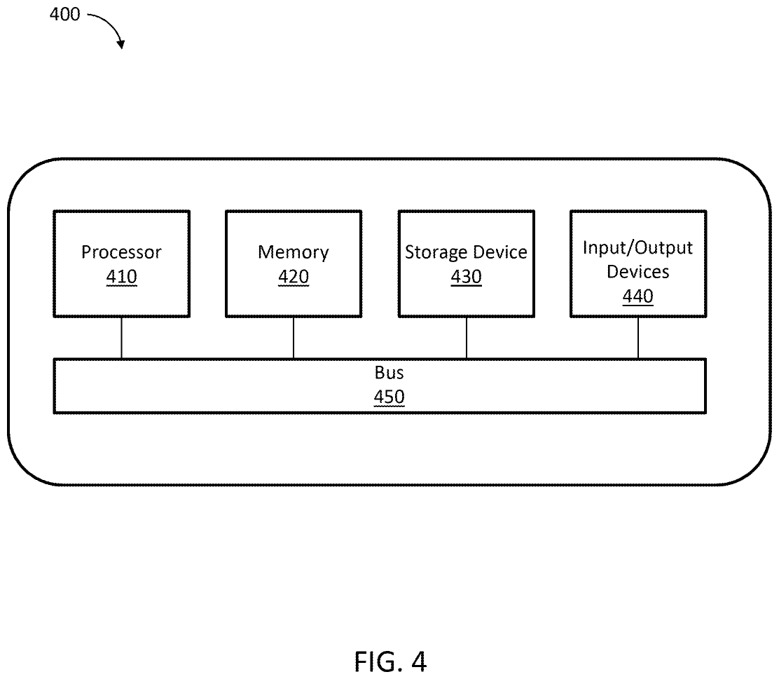

FIG. 4 depicts a block diagram illustrating a computing system 400 consistent with implementations of the current subject matter. For example, the system 400 can be used to implement the client devices, the server, and/or the like.

As shown in FIG. 4, the computing system 400 can include a processor 410, a memory 420, a storage device 430, and input/output devices 440. The computing system 400 may be used at the clients or the server. For example, the server 130 may execute the outlier detector 140A and the optimizer on one or more computing systems 400.

The processor 410, the memory 420, the storage device 430, and the input/output devices 440 can be interconnected via a system bus 450. The processor 410 is capable of processing instructions for execution within the computing system 400. Such executed instructions can implement one or more components of, for example, the trusted server, client devices (parties), and/or the like. In some implementations of the current subject matter, the processor 410 can be a single-threaded processor. Alternately, the processor 410 can be a multi-threaded processor. The processor may be a multi-core processor having a plurality or processors or a single core processor. The processor 410 is capable of processing instructions stored in the memory 420 and/or on the storage device 430 to display graphical information for a user interface provided via the input/output device 440.

The memory 420 is a computer readable medium such as volatile or non-volatile that stores information within the computing system 400. The memory 420 can store data structures representing configuration object databases, for example. The storage device 430 is capable of providing persistent storage for the computing system 400. The storage device 430 can be a floppy disk device, a hard disk device, an optical disk device, or a tape device, or other suitable persistent storage means. The input/output device 440 provides input/output operations for the computing system 400. In some implementations of the current subject matter, the input/output device 440 includes a keyboard and/or pointing device. In various implementations, the input/output device 440 includes a display unit for displaying graphical user interfaces.

According to some implementations of the current subject matter, the input/output device 440 can provide input/output operations for a network device. For example, the input/output device 440 can include Ethernet ports or other networking ports to communicate with one or more wired and/or wireless networks (e.g., a local area network (LAN), a wide area network (WAN), the Internet).

In some implementations of the current subject matter, the computing system 400 can be used to execute various interactive computer software applications that can be used for organization, analysis and/or storage of data in various (e.g., tabular) format (e.g., Microsoft Excel®, and/or any other type of software). Alternatively, the computing system 400 can be used to execute any type of software applications. These applications can be used to perform various functionalities, e.g., planning functionalities (e.g., generating, managing, editing of spreadsheet documents, word processing documents, and/or any other objects, etc.), computing functionalities, communications functionalities, etc. The applications can include various add-in functionalities (e.g., SAP Integrated Business Planning add-in for Microsoft Excel as part of the SAP Business Suite, as provided by SAP SE, Walldorf, Germany) or can be standalone computing products and/or functionalities. Upon activation within the applications, the functionalities can be used to generate the user interface provided via the input/output device 440. The user interface can be generated and presented to a user by the computing system 400 (e.g., on a computer screen monitor, etc.).

One or more aspects or features of the subject matter described herein can be realized in digital electronic circuitry, integrated circuitry, specially designed ASICs, field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system may include clients and servers. A client and server are generally remote from each other and typically interact through a communication network. The relationship of client and server arises by virtue of computer programs running on the respective computers and having a client-server relationship to each other.

These computer programs, which can also be referred to as programs, software, software applications, applications, components, or code, include machine instructions for a programmable processor, and can be implemented in a high-level procedural and/or object-oriented programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example, as would a processor cache or other random access memory associated with one or more physical processor cores.

To provide for interaction with a user, one or more aspects or features of the subject matter described herein can be implemented on a computer having a display device, such as for example a cathode ray tube (CRT) or a liquid crystal display (LCD) or a light emitting diode (LED) monitor for displaying information to the user and a keyboard and a pointing device, such as for example a mouse or a trackball, by which the user may provide input to the computer. Other kinds of devices can be used to provide for interaction with a user as well. For example, feedback provided to the user can be any form of sensory feedback, such as for example visual feedback, auditory feedback, or tactile feedback; and input from the user may be received in any form, including acoustic, speech, or tactile input. Other possible input devices include touch screens or other touch-sensitive devices such as single or multi-point resistive or capacitive track pads, voice recognition hardware and software, optical scanners, optical pointers, digital image capture devices and associated interpretation software, and the like.

In the descriptions above and in the claims, phrases such as “at least one of” or “one or more of” may occur followed by a conjunctive list of elements or features. The term “and/or” may also occur in a list of two or more elements or features. Unless otherwise implicitly or explicitly contradicted by the context in which it is used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” Use of the term “based on,” above and in the claims is intended to mean, “based at least in part on,” such that an unrecited feature or element is also permissible.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. For example, the logic flows may include different and/or additional operations than shown without departing from the scope of the present disclosure. One or more operations of the logic flows may be repeated and/or omitted without departing from the scope of the present disclosure. Other implementations may be within the scope of the following claims.

What is claimed is:

1. A system, comprising:
at least one data processor; and
at least one memory storing instructions which, when executed by the at least one data processor, result in operations comprising:
receiving a plurality of objects;
preprocessing the plurality of objects by at least normalizing one or more terms of the plurality of objects;
determining, for each of the plurality of objects, an aggregate value based on the one or more terms of the plurality of objects;
identifying, based on unsupervised learning clustering, at least one of a favorable outlier and an unfavorable outlier among the plurality of objects;
in response to identifying an unfavorable outlier, removing the identified unfavorable outlier from the plurality of objects; and
in response to removing the identified unfavorable outlier, providing at least one of the remaining plurality of objects.

2. The system of claim 1, wherein the unsupervised learning clustering comprises clustering based on an average gap value among aggregate values.

3. The system of claim 1, wherein the unsupervised learning clustering comprises:
sorting aggregate values generated for the plurality of objects; and
determining an average gap value among the aggregate values.

4. The system of claim 3, wherein the unsupervised learning clustering further comprises:
if a gap between a first aggregate value and a second aggregate value is less than or equal to the average gap value, the first aggregate value is assigned to a first cluster; and
if a gap between a first aggregate value and a second aggregate value is more than the average gap value, the first aggregate value is assigned to a second cluster.

5. The system of claim 1, wherein the preprocessing further comprises:
identifying a first term from the one or more terms as a maximization term; and
negating, before the determining of the aggregate value, the first term.

6. The system of claim 1, wherein the normalizing includes determining a z-score for the one or more terms for each of the plurality of objects.

7. The system of claim 1, wherein the determining of the aggregate value comprises determining a sum of the normalized one or more terms for each of the plurality of objects.

8. The system of claim 1, wherein the providing at least one of the remaining plurality of objects comprises:
generating a user interface including an indication of the at least one of the remaining plurality of objects including the favorable outlier; and
causing the generated user interface to be presented at a client device.

9. The system of claim 1, wherein plurality of objects comprise a plurality of bids.

10. A method comprising:
receiving a plurality of objects;
preprocessing the plurality of objects by at least normalizing one or more terms of the plurality of objects;
determining, for each of the plurality of objects, an aggregate value based on the one or more terms of the plurality of objects;
identifying, based on unsupervised learning clustering, at least one of a favorable outlier and an unfavorable outlier among the plurality of objects;
in response to identifying an unfavorable outlier, removing the identified unfavorable outlier from the plurality of objects; and
in response to removing the identified unfavorable outlier, providing at least one of the remaining plurality of objects.

11. The method of claim 10, wherein the unsupervised learning clustering comprises clustering based on an average gap value among aggregate values.

12. The method of claim 10, wherein the unsupervised learning clustering comprises:
sorting aggregate values generated for the plurality of objects; and
determining an average gap value among the aggregate values.

13. The method of claim 12, wherein the unsupervised learning clustering further comprises:
if a gap between a first aggregate value and a second aggregate value is less than or equal to the average gap value, the first aggregate value is assigned to a first cluster; and
if a gap between a first aggregate value and a second aggregate value is more than the average gap value, the first aggregate value is assigned to a second cluster.

14. The method of claim 10, wherein the preprocessing further comprises:
identifying a first term from the one or more terms as a maximization term; and
negating, before the determining of the aggregate value, the first term.

15. The method of claim 10, wherein the normalizing includes determining a z-score for the one or more terms for each of the plurality of objects.

16. The method of claim 10, wherein the determining of the aggregate value comprises determining a sum of the normalized one or more terms for each of the plurality of objects.

17. The method of claim 10, wherein the providing at least one of the remaining plurality of objects comprises:
generating a user interface including an indication of the at least one of the remaining plurality of objects including the favorable outlier; and
causing the generated user interface to be presented at a client device.

18. The method of claim 10, wherein plurality of objects comprise a plurality of bids.

19. A non-transitory computer-readable storage medium including instructions which, when executed by at least one data processor, causes operations comprising:
receiving a plurality of objects;
preprocessing the plurality of objects by at least normalizing one or more terms of the plurality of objects;
determining, for each of the plurality of objects, an aggregate value based on the one or more terms of the plurality of objects;
identifying, based on unsupervised learning clustering, at least one of a favorable outlier and an unfavorable outlier among the plurality of objects;
in response to identifying an unfavorable outlier, removing the identified unfavorable outlier from the plurality of objects; and
in response to removing the identified unfavorable outlier, providing at least one of the remaining plurality of objects.
